(19) United States
(12) Patent Application Publication
(10) Pub. No.: US 2009/0240570 A1
(43) Pub. Date: Sep. 24, 2009

(54) DEVICE AND METHOD FOR THE ANALYSIS OF INFORMATION CONCERNING PRODUCTS OR SERVICES BY CORRELATION WITH SETS OF RULES

(75) Inventors: Fabien Balageas, Nozay (FR); Benoit Christophe, Nozay (FR)

Correspondence Address: FAY SHARPE/LUCENT, 1228 Euclid Avenue, 5th Floor, The Halle Building, Cleveland, OH, 44115-1843, US

(73) Assignee: Alcatel-Lucent

(21) Appl. No.: 12/404,632

(22) Filed: Mar. 16, 2009

(30) Foreign Application Priority Data
Mar. 18, 2008 (FR) 0851733

(51) Int. Cl. G06Q 10/00

(52) U.S. Cl. 705/10; 705/7

(57) ABSTRACT

A device (D) is dedicated to the analysis of information concerning products and services. Said device (D) comprises analysis tools (MA) intended, in the event of reception of an identifier representing a product or service, to access a first set of data to identify such a product or service among them, as a function of the identifier received, then to access at least one source of information (SI) in order to research information therein about the identified product or service, then to determine from among the information thus researched whether the identified product or service satisfies a chosen set of at least one rule, and to deliver a message indicating at least the result of such determination.

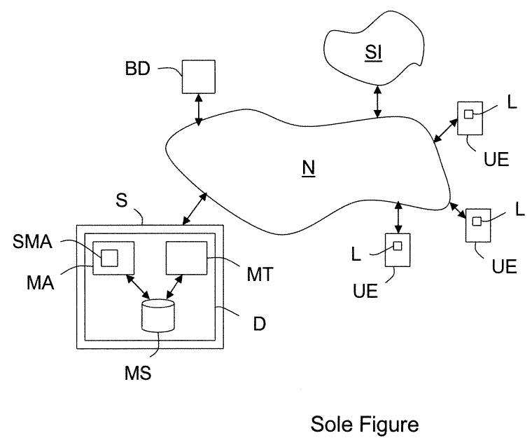

The invention concerns the domain of the analysis of information concerning products and services.

When a person wishes to buy or use a product or a service, he/she may wish directly to obtain some information thereon. As an example, a person could wish to know where and under what conditions a product is manufactured in order to verify whether those conditions correspond to his/her ethical or deontological criteria and/or rules, in particular, or else whether the person in question may consume a product taking into account his/her potential medical and/or physical and/or religious restrictions.

To obtain such information on products or services one wishes to buy or use, there are at least four solutions.

A first solution consists in oneself carrying out research with information sources, such as websites, by means of a browser (search engine) of a communications device, or with friends by means of phone calls or emails also by means of a communications device. This first solution is generally not very effective and/or tedious and/or time consuming.

A second solution consists in obtaining, from third parties, analytical abstracts or reports concerning the product or service by means of a communications device. This second solution requires analysis of the abstracts or reports, which can be very time consuming. Moreover, this solution may be unreliable because the abstracts and reports may not be recent. Furthermore, it may be difficult to correlate the information contained in abstracts or reports obtained from different information sources.

A third solution consists in using a tool enabling a product or service identifier, such as a barcode or an identifier (potentially of the RFID type), to be obtained. Such tools are marketed, for example, by Baracoda and Symbol. The main disadvantage of this solution resides in the fact that the tools were developed for industrial purposes (e.g. for assembly chains or to manage inventories, or else to limit theft) and are therefore very little used by the public at large. Moreover, these tools enable only identification of the products and not general information relating to them to be obtained, and much less yet a verification as to whether the products would satisfy any particular criteria or rules.

A fourth solution consists in carrying out text research by means of a rule engine. The main disadvantage of this solution resides in that a rule engine does not enable correlations between items of information obtained from sources using different storage formats. Moreover, it is difficult to query a rule engine if the product has not been precisely identified. Furthermore, use of a rule engine requires understanding and mastery of its language (which is generally not a natural language), which is not always easy, in particular for a neophyte.

As no known solution is fully satisfactory, the goal of the invention is therefore to improve the situation.

For this purpose, the invention proposes a method dedicated to the analysis of information concerning products and services, and consisting in:
identifying a product or service among a first set of data, as a function of an identifier representing it,
researching, in at least one source of information, information relative to the identified product or service,
determining whether the identified product or service satisfies a set of at least one chosen rule, taking into account the information searched for, and
delivering a message indicating at least the result of the determination.

The method of the invention may comprise other characteristics, which may be taken separately or in combination, in particular:
when the identified product or service does not satisfy the chosen set of criteria, a message can be delivered equally indicating at least one reason for such failure to satisfy;
when there is a possibility that the identified product or service may not satisfy the chosen set of criteria, a message can be delivered equally indicating at least one reason for this possibility of such failure to satisfy;
when the identified product or service does not satisfy the chosen set of criteria or there is a possibility that the identified product or service may not satisfy the chosen set of criteria, an attempt can be made to determine at least one product or service substantially equivalent to those identified, and therefore satisfying the chosen set of rules, so as to deliver a message equally indicating each substantially equivalent product or service thus determined;
the identification of a product or service may be either “strong” if it leads to the determination of a product or service class instance, or “weak” if it leads to the determination of a product or service class appurtenance. In this case, it is possible to have rules of a general scope for weak identification and/or rules of a (highly) precise scope for strong identification;
the rule sets can dynamically evolve over time, e.g. as a function of the context;
each identifier may e.g. be chosen from among (at least) a barcode and an identifier (potentially of the RFID type);
the identifier can be obtained and then supplied by means of user equipment;
at least some of the sets of rules may be associated to users possessing equipment;
   it is possible to generate at least some of the rules on the basis of “pre-rules” defined in natural language or as a pseudo-constraint by users and which are supplied by the equipment such users possess;
   certain rules of certain sets associated to users may originate from sets of rules associated to legal persons (e.g. governmental or non-governmental organizations) selected by users because of the trust they place in them (thus enabling simplification of the set definition work for a user who may accept default rules while preserving the possibility to modify them at a later stage);
   different levels of importance can be assigned to the rules so as to take into account only those rules that have the highest level of priority when a set contains antagonistic or conflicting rules;
the rules may relate to the purchase or use of one or more product(s) or service(s);
certain rules may apply on a temporary basis for a selected period of time;
certain rules may be generated on the basis of text portions of digital documents selected by users and describing ideas they subscribe to.

The invention also proposes a device dedicated to the analysis of information concerning products and services, and comprising analysis tools intended, in the event of reception of an identifier representing a product or service, i) to access a first set of data in order to identify among them the product or service, depending on the identifier received, then ii) to access at least one source of information to search within it for information relating to the identified product or service, then iii) to determine whether the identified product or service satisfies a set of at least one rule chosen taking into account the information searched for, and iv) to deliver a message indicating at least the result of said determination.

The device of the invention may comprise other characteristics, which may be taken separately or in combination, in particular:
its analysis tools may be intended, when the identified product or service does not satisfy the chosen set of criteria, to deliver a message equally indicating at least one reason for such failure to satisfy;
its analysis tools may be intended, when there is a possibility that the identified product or service may not satisfy the chosen set of criteria, to deliver a message equally indicating at least one reason for this possibility of such failure to satisfy;
its analysis tools may be intended, when the identified product or service does not satisfy the chosen set of criteria or there is a possibility that the identified product or service may not satisfy the chosen set of criteria, to attempt to determine at least one product or service substantially equivalent to the identified product or service, and therefore satisfying the chosen set of rules, so as to deliver a message equally indicating each substantially equivalent product or service thus determined;
its analysis tools may be intended to effect product or service identifications called either “strong” if they culminate in determination of an instance of a class of product or service, or else “weak” if they culminate in determination of an appurtenance to a class of product or service. In that case, it is possible to have rules of a general scope for weak identification and/or rules of a (highly) precise scope for strong identification;
the device may comprise transcription means intended, in the event of reception of a “pre-rule” defined in natural language or as a pseudo-constraint by a user and supplied by the latter's equipment, to transcribe the pre-rule into a rule for the set associated to the user;
its analysis tools may be intended, in the presence of an identified product or service and of a set including rules associated to different levels of importance and in certain cases antagonistic among themselves, to take into account only the rules with the highest level of priority;
its analysis tools may be intended, in the presence of a rule that is temporarily applicable for a selected period of time, to apply the said temporary rule only during its period of application.

The invention also discloses a server intended to be connected to a communication network and equipped with an analytical device of the type described hereinabove.

Other characteristics and advantages of the invention will become apparent upon examining the detailed description below, and the attached drawing, in which the sole FIGURE very schematically depicts a server equipped with an embodiment of an analytical device according to the invention and connected to a communication network to which user communication equipment is also connected. The drawing may serve not only to complete the invention, but also to contribute to defining it, if applicable.

The goal of the invention is to enable collection of information concerning products or services with a view to verifying whether they satisfy certain rules (or criteria).

All types of products and/or services are concerned by the invention, always providing that they can be identified.

The invention proposes a method dedicated to the analysis of information concerning products and services. A method of this kind comprises four main stages.

A first stage consists in identifying a product or service among a first set of data, as a function of an identifier representing it.

All types of product or service identifiers may be used, always provided that they represent a product or service in an absolutely or relatively unambiguous manner. Thus, they could consist in a barcode or an identifier on a product, such as a serial number, or be stored in a memory carried by a product, such as an electronic chip memory of a (passive or semi-passive) RFID type radio label.

As illustrated in the sole FIGURE, an identifier can for example be obtained by means of a device UE equipped with an appropriate reader L, such as a barcode or RFID identifier reader (usually referred to as IPCs or “International Product Codes”).

Identifiers are transmitted to an information analysis device D according to the invention. This device (D) is preferably accessible via a communication network N. It could, for example, be part of a server S connected to the communication network N (as illustrated in the sole FIGURE). However, it could also be coupled to a server or constitute a communicating device.

The identifiers are transmitted to the device D (or to the server S containing it or to which it is coupled) by communication devices that may be connected to the communication network N and which are preferably the abovementioned devices UE (equipped with (or coupled to) a reader L). Such devices UE shall preferably be of relatively small dimensions, such as for example mobile or cellular telephones (potentially of the “smartphone” type), equipped with a reader L, or Personal Digital Assistants (PDAs, potentially of the Pocket PC type), capable of communicating and equipped with a reader L. Such devices would preferably belong to users who have subscribed to a communication network. In that case, when a user wishes to know whether he/she could buy a product (or service) placed before him/her, he/she will use the device UE in order to obtain the identifier of the said product by means of the reader L, then the device UE would transmit this identifier to the device D (for example thanks to a dedicated application), via the communication network N.

It will be understood that it is advantageous in this context that the communication network N should be a wireless network, such as for example a cellular or mobile type network (GSM, GPRS/EDGE, UMTS or CDMA (2000)), or of the WLAN type (Wireless Local Area Network—such as a WiMAX or Wi-Fi network).

It should be noted that in a variant, a device UE may be equipped with its own analytical device D.

It is the analytical device D that would have the task of identifying a product or service among a first set of data, as a function of an identifier representing it. To so this, it would comprise an analytical module MA which more particularly has the task of accessing the first set of data each time its device D receives a product or service identifier.

The first set of data is, for example, stored in databases BD corresponding to the identifiers. As illustrated, these databases BD are for example accessible to the device D via the communication network N. They may belong to (or be a part of) Internet sites, or else be directly accessible subject to prior access authorizations (which can turn out to be faster).

For example, if the analytical module MA has received a product barcode, it will access a database BD that stores barcodes in order to determine the first data stored there and corresponding to the barcode received, which identify the product.

It will be noted that the analytical module MA can perform product or service identifications referred to as being “strong” or “weak”. A strong identification is an identification that culminates in determination of an instance of a class of product or service (such as a particular model of a specific car manufactured by a specific car maker). A weak identification is an identification that culminates in determination of an appurtenance to a class of product or service (such as the class “car”).

A second stage of the method according to the invention consists in researching in at least one source of information SI information relative to a product or service identified during a first stage,

It will be understood that this research is equally performed by the analytical device D. More specifically, when the analytical module MA has identified a product or service, it accesses at least one source of information SI to search in it for information relative to the said identified product or service, Such searches may be conducted by means of a search module, such as a search engine (or similar).

The sources of information SI can be of any kind. It is therefore possible that they might be Internet sites that are accessible to the device D via the communication network N. Such Internet sites Si may for example belong to the manufacturers of the products or to the companies offering the services or to distributors of the products or to companies specialized in conducting research into companies and their mode of operation or to companies specialized in product and/or service analysis, or to publishing companies or the press (in particular as concerns their digital publications) or even to governmental or non-governmental organizations in particular. They could also be forums or article database sites or even “blogs”, for example. It will be noted that a user can assign different levels of confidence to the different sources of information SI.

A third stage of the method according to the invention consists in determining whether a product or service (identified during a first stage) satisfies a selected set of at least one rule (or one criterion), taking into account the information researched during a second stage.

It will be understood that this research is equally performed by the analytical device D. More specifically, when the analytical module MA has determined information concerning an identified product or service, it verifies whether the latter satisfies a selected set of at least one rule (or one criterion).

It will also be understood that the set of rules chosen to effect a verification is a set that is associated to the physical person (user) or legal person (company) that initially supplied the identifier underlying the verification.

In other words, if an identifier is supplied by a user, the analytical module MA uses the set of rules (or criteria) associated to that user.

The rules shall preferably relate to the purchase or use of one or more product(s) or service(s).

The data that define each set of rules are preferably stored in storage means MS, such as a database or a memory corresponding to identifiers of users (or companies), such as the communication identifiers of their devices UE.

The said storage means MS would, for example, be part of the device D as illustrated in the sole FIGURE. However, this is not mandatory. They may, in effect, be part of the Server S.

It will be noted that it would also be possible to envisage that the set of rules to be used is transmitted at the same time as the identifier. In the latter case, the data defining the set of rules are stored in the users device UE and transmitted at each query.

The rules (or criteria) constituting a set associated, for example, with a user may be of any origin. Thus, a set could comprise only the first rules (or criteria) that had been defined by a user or else by one or more governmental or non-governmental organizations or companies or even non-profit associations (potentially consumer associations) or else in fact by the device D itself. However, a set could simultaneously comprise the first rules (or criteria) that had been defined by a user and also second rules (or criteria) defined by one or more governmental or non-governmental organizations or companies or even non-profit associations (potentially consumer associations) or else in fact by the device D itself.

It will be noted that in order to simplify the work concerning the definition of his/her set, the user can simply select one or more governmental or non-governmental organizations or one or more companies or in fact one or more non-profit associations (potentially consumer associations) according to the level of confidence he/she assigns to such entities. In this case, the user's set of rules will automatically and by default comprise the rules of each organization or company or association selected by him/her. Of course, the user retains the option later to remove (or modify) some of those rules, and/or to add other rules to the first set.

The following is a non-exhaustive list of examples, regarding certain rules defined by a non-governmental organization X:
“X recommends building one's house out of wood”,
“X recommends not buying the products of [company] Y”,

“X recommends not buying products containing the substance Z”,
“X calls for a boycott of products manufactured by [the company] H because [H] uses child labor”,
“X recommends buying fair trade products”,
“X recommends not buying products that do not comply with animal protection legislation”,

It will be noted that certain rules can have a general scope in order to be used further to a weak identification, and other rules can have a (very) precise scope in order to be used further to a strong identification. For example, a user's set of rules may comprise a rule defined by a non-governmental organization recommending use of public transportation and therefore strongly discouraging purchase of a car, regardless of type or brand. A user's set of rules could also comprise a rule defined by a non-governmental organization recommending use of a particular brand due to the fact that it may have received special acclaim concerning environmentally friendly qualities, e.g. from the European Union.

As indicated above, the device D can suggest rules to the users that they themselves may have defined based on information stored in information sources such as specialized dictionaries or encyclopedias. This could in particular be the case for medical or pharmaceutical rules.

For a user to be able to define his/her set of rules, his/her equipment UE may be equipped with a dedicated application that can, for example, enable him/her to access public sets of rules defined by governmental or non-governmental organizations or companies or even non-profit associations (potentially consumer associations) in order to select all or part of their rules. This selection can take place locally (i.e. in the equipment UE) when the public rule sets have been downloaded into the equipment UE, and/or remotely when the public rule sets are accessible via a dedicated website of the server S.

This dedicated application can also potentially enable the user to select text portions in digital documents describing ideas he/she subscribes to. In that case, the dedicated application generates rules based on selected text portions and integrates such rules into the pertinent user's set (potentially after having been presented to him/her with a view to getting his/her approval).

It is important to note that certain rules constituting a set of rules are not compellingly those that were defined and supplied by a user by means of the dedicated application. In fact, the invention enables a user to provide “pre-rules” in natural language or as a pseudo-constraint. In that case, each pre-rule is transcribed into a rule that is comprehensible (and usable “as is”) by the analytical module MA to effect a verification (by correlation of rule(s)/information).

Said transcription can be performed by means of a transcription module MT. This module would preferably be a component of the device D. However, it is possible to envisage that it might be a component of the dedicated application installed in each equipment UE and enabling the user to define and/or select rules to constitute his/her set of rules.

It will be noted that transcription can require access by the transcription module MT to information data that are stored (and accessible via the communication network N). This can in particular be the case when a pre-rule relates e.g. to medical or pharmaceutical indications that could serve to build a subset of rules taking into account public medical or pharmaceutical information such as that contained in a specialized dictionary.

There follows, by way of example, a non-exhaustive list of certain user pre-rules:
“I am allergic to soy”,
“I don't like potatoes”,
“Do not select products containing more than 30% fat”,
“I don't eat pork”,
“I am a vegetarian”.

When the data defining a set of rules that is associated to a user are stored in the storage means MS, they are in fact updated each time the user modifies them by means of the dedicated application (and therefore via the communication network N). The rule sets can thus dynamically evolve over time, e.g. as a function of the context.

Besides, when the data that define the sets of rules associated to the users and companies are stored in the storage means MS, each time the analytical module MA must effect a verification (third stage) for a user or a company, it accesses the storage means MS to extract and then use the set of rules stored therein corresponding to the user's or the company's communication identifier.

Once the analytical module MA has a set of rules to apply and information relating to a product or service, it can proceed to the verification step (by correlation between the rule(s) and the information). To do so, it may for example comprise a sub-module SMA designed to carry out semantic research in order to understand the meaning of the information obtained for the identified product or service, and then to verify whether that product or service meets a chosen set of rules taking into account the meaning of the relevant related information.

In this context “semantic research” shall mean research performed by means of pertinent key words that define a subject, if appropriate combined with non-pertinent key words such as articles, prepositions or conjunctions.

Once the SMA sub module has completed a verification, it furnishes a result.

Any type of result may be delivered. Thus, a result may consist in a dedicated code meaning that the identified product or service meets the selected rule set, or in a dedicated code meaning that the identified product or service does not meet the selected rule set, or even a dedicated code meaning that there is a possibility that the identified product or service may not satisfy the chosen rule set. However, a code can be replaced with a literal expression.

It should be noted that a result can also and potentially be completed with other information. Thus, when the dedicated code means that the identified product or service does not meet the chosen set of rules, it may be accompanied by at least one reason explaining this failure to satisfy. Similarly, if the dedicated code means that there is a possibility that the identified product or service may not meet the chosen set of rules, it may be accompanied by at least one reason explaining this potential failure to satisfy. The reason could, for example, be a rule that has not been satisfied and that would then be named.

It is also possible to envisage, when the dedicated code signifies that the identified product or service does not meet the selected rule set, or that there is a possibility that the identified product or service may not satisfy the chosen rule set, it should be accompanied (if at all possible) by a (summary) description of at least one product or service substantially equivalent to the identified product or service, and therefore satisfying the chosen set of rules.

It will be understood that this latter case necessitates the analytical module MA of the device D to effect new research and verifications (by correlation) in databases and sources of information SI in order to determine whether there really is or are one or more equivalent product(s) or service(s) that would satisfy the chosen set of rules.

As an illustration, by way of example, the device D could use the database of the products sold by a supermarket in which a user having launched a verification concerning a product he/she wishes to purchase is present at the time in order to research one or more products equivalent to that desired by the shopper. It will then search for information related to such equivalent product(s) and verify whether the latter meet(s) the chosen rules set, taking into account the meaning of the relevant information, and, in the affirmative, the dedicated code may be accompanied by the summary description of each equivalent product or service, while, if the answer is negative, the dedicated code may be accompanied by an expression such as “no equivalent available”, for example.

It will be noted that supplementary information can also designate replacement or substitution products. This can be the case when rules are of a contextual type. By way of example but not of limitation, a rule in a set of rules might indicate that the user associated to it only wants to consume seasonal fruit and vegetables. In that case, when the user has transmitted a verification request in regard to the purchase of a fruit or vegetable, the analytical module MA of the device D will determine in the sources of information whether the identified fruit or vegetable is indeed in season taking into account the country in which the user is located. If the answer is negative, other seasonal fruit and vegetables may potentially be researched and suggested by means of additional information.

A fourth stage of the method according to the invention consists in delivering a message indicating at least the result of a determination (verification) performed during a third stage.

It will be understood that this message is also delivered by the analytical device D and transmitted to the equipment UE that had supplied the identifier and therefore requested the verification. More precisely, when the analytical module MA has obtained the result of a verification as well as potential other supplementary information (resulting from research and additional verifications, e.g. in order to find equivalent products or services), it generates a message indicating the result as well as the potential additional information in natural language or as a pseudo-constraint. Then, it will request its device to transmit that message to the pertinent equipment UE. The said message is then displayed on the screen of the equipment UE in text format (it could potentially be converted into a sound message broadcast by the speaker of the equipment UE).

It will be noted that certain rules of a set may apply on a temporary basis for a selected period of time. This could, for example, be the case of rules defined on the basis of medical prescriptions or because of temporary dietary constraints.

There follows, by way of example, a non-exhaustive list of certain temporary rules:
“Do not eat dairy products for a week”,
“Eat bananas and rice once a day for three days”,
“Do not drink milk for a week”,

As previously indicated, some of these rules may be defined by the device D (e.g. by its transcription module MT) based on rules supplied by a user and on information obtained from specialized databases. This can in particular be the case of rules resulting from medical prescriptions designating medication that must not be used concurrently with other drugs or products. Thus, the rule “Don't drink milk for a week” could result from the fact that a user had, further to having obtained a medical prescription, supplied a rule indicating that he/she must take a medication W for a week and that there is in addition a contraindication as concerns milk consumption in combination with the medication W.

It will be noted that certain temporary rules can constitute alert rules defined by a governmental organization in order to indicate a danger. They would then be presented as a recommendation in favor of (or a prohibition from) consuming one or more products originating from a specific area (or region). For example, it could be recommended not to eat the fish and shell fish from a given lake or sea area. Such temporary alert rules can potentially be automatically included in each set of rules stored in the storage means MS of the device D, if appropriate with the authorization of the relevant user.

The analytical module MA can therefore be designed so as to use a rule involving a temporary constraint only during the period of utilization indicated in the rule, and starting from its date of storage in the storage means MS. Upon expiration this period of utilization, the analytical module MA is designed so as to delete the temporary rule from the storage means MS. It will be understood that a temporary rule newly added to a users set of rules will be used in each new verification request made by that user during its period of utilization.

It is important to note that the analytical module MA of the device D can potentially be designed in a manner such as to perform verifications when sets contain antagonistic (or conflicting) rules. This situation can, in particular, come about when a user decides to constitute his/her set of rules on the basis of his/her own first rules (the pre-rules) and of a second set of rules defined by one or more legal persons.

So that the analytical module MA can become capable of resolving inter-rule conflicts, it is possible for example to envisage that users will attribute different levels of importance to at least some of the rules they select to constitute their respective sets. The rules are then stored according to their level of importance. In that case, when the analytical module MA is in the presence of a set comprising at least one pair of antagonistic (or conflicting) rules, it is designed so as not to take account of the rule of each pair that is associated with the lowest level of importance.

The information analysis device D according to the invention, and more particularly its analytical module MA and its (potential) transcription module(s) MT and storage means MS are preferably embodied in the form of software (or information technology) modules. However, they may also be constructed in the form of electronic circuits or of a combination of electronic circuits and software modules suitable to communicate with each other via an appropriate interface.

The invention is not limited to the embodiments of an information analysis device, a server and the information analysis method described above, but, rather, is represented here only by way of example, while it encompasses all variants a person skilled in the art may envisage within the framework of the claims below.

1. Method for analyzing information about products and services, characterized in that it consists in i) identifying a product or service among a first set of data, as a function of an identifier representing it, ii) researching, in at least one source of information, information concerning the said identified product or service, iii) determining whether the said identified product or service satisfies a set of at least one rule selected taking into account the said researched information, and iv) delivering a message indicating at least the result of the said determination.

2. Method according to claim 1, characterized in that when the said identified product or service does not satisfy the chosen set of rules, a message will be delivered equally indicating at least one reason for such failure to satisfy.

3. Method according to claim 1, characterized in that when there is a possibility that said identified product or service may not satisfy the chosen set of rules, a message will be delivered equally indicating at least one reason for such possibility of a failure to satisfy.

4. Method according to claim 1, characterized in that when the said identified product or service does not satisfy the chosen set of rules, or if there is a possibility that the said identified product or service may not satisfy the said chosen set of rules, an attempt is made to determine at least one product or service substantially equivalent to those identified, and therefore satisfying the said chosen set of rules, so as to deliver a message equally indicating each substantially equivalent product or service thus determined.

5. Method according to claim 1, characterized in that products or services are identified as being of a “strong” type by virtue of the fact that they culminate in determinations of instances of classes of products or services, or else of a “weak” type by virtue of the fact that they culminate in determinations of an appurtenance to a class of product or service.

6. Method according to claim 1, characterized in that at least some of the sets of rules will dynamically evolve over time.

7. Method according to claim 1, characterized in that each identifier is chosen from a group comprising at least one barcode and one identifier.

8. Method according to claim 1, characterized in that the said identifier is obtained and then supplied by means of a user equipment (UE).

9. Method according to claim 1, characterized in that at least some of the sets of rules are associated to users having equipment (UE).

10. Method according to claim 9, characterized in that at least some of the rules are generated based on “pre-rules” defined in natural language or as a pseudo-constraint by users and supplied by the equipment (UE) in their possession.

11. Method according to claim 9, characterized in that certain rules of certain sets associated to users originate from one or more sets of rules associated to legal persons selected by the said users.

12. Method according to claim 9, characterized in that different levels of importance are assigned to at least some of the rules, and in that in the presence of a set including rules that are antagonistic among themselves, only the rules with the highest level of priority are taken into account.

13. Method according to claim 1, characterized in that the said rules relate to the purchase or use of one or more product(s) or service(s).

14. Method according to claim 1, characterized in that certain rules shall apply on a temporary basis for a selected period of time.

15. Method according to claim 1, characterized in that certain rules are generated on the basis of text portions of digital documents selected by users and describing ideas they subscribe to.

16. Device (D) for the analysis of information concerning products and services, characterized in that it comprises means of analysis (MA) designed, in the event of receipt of an identifier representing a product or service, to access a first set of data to identify the said product or service among them as a function of the said identifier as received, and then to access at least one source of information (SI), therein to research information about the said identified product or service, then to determine, by means of the said researched information, whether the said identified product or service satisfies a set of at least one selected rule, and to deliver a message indicating at least the result of the said determination.

17. Device according to claim 16, characterized in that when the said identified product or service does not satisfy the chosen set of rules, the said means of analysis (MA) are designed in a manner such as to deliver a message equally indicating at least one reason for such failure to satisfy.

18. Device according to claim 16, characterized in that when there is a possibility that said identified product or service may not satisfy the chosen set of rules, the said means of analysis (MA) are designed in a manner such as to deliver a message equally indicating at least one reason for such possibility of a failure to satisfy.

19. Device according to claim 16, characterized in that when the said identified product or service does not satisfy the chosen set of rules, or if there is a possibility that the said identified product or service may not satisfy the said chosen set of rules, the said means of analysis (MA) are designed in a manner such as to attempt to determine at least one product or service substantially equivalent to those identified, and therefore satisfying the said chosen set of rules, so as to deliver a message equally indicating each substantially equivalent product or service thus determined.

20. Device according to claim 16, characterized in that the said analysis tools (MA) are designed to effect product or service identifications called either “strong” if they culminate in determination of an instance of a class of product or service, or else “weak” if they culminate in determination of an appurtenance to a class of product or service.

21. Device according to claim 16, characterized in that at least some of the sets of rules are associated to users having equipment (UE).

22. Device according to claim 21, characterized in that it comprises transcription means (MT) designed, in the event of reception of a “pre-rule” defined in natural language or as a pseudo-constraint by a user and supplied by the latter's equipment (UE), to transcribe the said pre-rule into a rule for the set associated to the said user.

23. Device according to claim 21, characterized in that certain rules of certain sets associated to users originate from one or more sets of rules associated to legal persons selected by the said users.

24. Device according to claim 21, characterized in that the said analysis tools (MA) are designed, in the presence of an identified product or service and of a set including rules associated to different levels of importance and in certain cases antagonistic among themselves, to take into account only the rules with the highest level of priority;

25. Device according to claim 16, characterized in that the said rules relate to the purchase or use of one or more product(s) or service(s).

26. Device according to claim 16, characterized in that the said analysis tools (MA) are designed, in the presence of a rule that is temporarily applicable for a selected period of time, to apply the said temporary rule only during its period of application.

27. Device according to claim 16 implemented in a server (S) for a communication network, characterized in that the device comprises an analytical device (D).
